(19) United States
(12) Patent Application Publication
(10) Pub. No.: US 2024/0381808 A1
(43) Pub. Date: Nov. 21, 2024

(54) Seed Planting Apparatus

(71) Applicants: Matthew Linko, Beaver Falls, PA (US); Salvatore Miscio, Lambertville, MI (US)

(72) Inventors: Matthew Linko, Beaver Falls, PA (US); Salvatore Miscio, Lambertville, MI (US)

(73) Assignees: Salvatore Miscio, Lambertville, MI (US); Matthew Linko, Beaver Falls, PA (US)

(21) Appl. No.: 18/221,017

(22) Filed: Jul. 12, 2023

Related U.S. Application Data
(60) Provisional application No. 63/400,096, filed on Aug. 23, 2022.

(51) Int. Cl. A01C 7/02; A01C 1/04; A01C 5/02

(52) U.S. Cl. CPC A01C 7/02; A01C 1/046; A01C 5/02

(57) ABSTRACT

An implement revolving around agriculture, prepared for quickly planting and germinating seeds. No device has seen all these classifications incorporated into one apparatus successfully. Each apparatus contains one or more seeds. The depth of each seed is positioned on the apparatus so that the depth of planting into the ground is correct. Each apparatus is impregnated with fertilizer directly into the substrate. The Fertilizer then acts as a slow time release application, during plant growth. Each Seed is affixed with an organic adhesive to protect the end user and fully adhere the seed to the apparatus. The novel apparatus also has a final quality of digging the appropriate size hole for the seed to be planted in.

EFFECT: This novel apparatus will increase consumer productivity and success in gardening.

### CROSS-REFERENCE TO RELATED APPLICATIONS

Pursuant to Section 35 of US Code 119, this application claims priority to provisional patent application U.S. No. 63/400,096, filed Aug. 8, 2022, which is incorporated herein by reference in its entirety.

### FIELD OF THE INVENTION

This invention relates to utility of Agricultural implements. More Specifically, but not exclusively, the invention relates to a seeder with the ability to carry many different sizes of seeds, plant them at different depths, and disperse fertilizer over prolonged periods of time.

### PRIORITY CLAIMED BY FROM THE PROVISIONAL 63/400,096

Filed on: Aug. 22, 2022
Filed by: Matthew Linko & Salvatore Miscio
Application granted: Aug. 31, 2022
Provisional No. 63/400,096

### BACKGROUND OF THE INVENTION

An agricultural seed planting, fertilizing, and soil preparation device. In its most basic form, devices like these are typically just a seed that is placed into the ground, hoping that germination occurs with no afterthought for seed fertilization, or seed depth.

The depth of the seed is not typically considered, although all seeds have required depths. If a seed is planted too deep, it may not germinate. If a seed is planted too shallow, it can have a week root system and die during stressful weather conditions. Placing a seed into the dirt is just one function. A seed must also be fed during its life. Many devices do not take this into account, and you must fertilize manually. Commonly this device is used as a marketing promotional item, or a tradeshow giveaway. It was never truly engineered to be a self-supporting apparatus. However, the digging of the hole for each seed has never been done with the seed apparatus until now.

Planting a seed usually consists of several Items to perform the task. Including Shovels, Measuring Stick, Fertilizer, and of course Seeds. To have one novel apparatus to perform all of these tasks will provide a complete seed delivery system.

Now that the proper items are located within one device the sowing speed increases. Productivity increases, as well as the success rate of germination.

Consequently, there is a need in the art for an agricultural seed apparatus that includes a seed device that facilitates seed germination, fertilization, proper depth, and a digging edge as well. This leads to a more successful harvest and user-friendly experience.

### SUMMARY OF THE INVENTION

As a result of this, the fundamental task, feature and/or advantage of the presented invention is to eliminate the disadvantages in this technical field.

Another objective, feature and/or advantage of the presented invention is to create an agricultural seeder to ensure proper depth is achieved.

Another objective, feature and/or advantage of the present invention is to create a device/mechanism which will deliver the seeds from the seed apparatus device into the soil.

Another objective, feature and/or advantage of the present invention is to provide a seed device that will provide an optimized amount of fertilizer during the germination period and plant life.

An additional task, feature and/or advantage of the presented invention is to create a seed apparatus that can increase the rate at which you can sow.

An additional objective, feature and/or advantage of the present invention is to provide a seed apparatus that can also prepare the soil around the planting site.

Another objective, feature and/or advantage of the present invention is to provide an adhesive that is organic, biodegradable, and safe to consume.

These and/or other objects, features and advantages of the present invention will be apparent to those skilled in the art. The presented invention should not be limited to these tasks, features and advantages. No option for implementation should provide all these single tasks, features or advantages.

The presented invention relates to the seed delivery system to provide the necessary germination, seed depth, fertilization, and soil preparation.

### BRIEF DESCRIPTION OF DRAWINGS

FIG. 1

In FIG. 1 (100) Show's the definitive line (310) that the apparatus will be planted at. This figure also includes the Digging portion (220) of the tool to remove dirt. Also, shown the organic edible adhesive (110) that is used to adhere the seed (120) to the apparatus.

FIG. 2

In FIG. 2 (200) we see the laser etched seed (120) name label (410) to avoid fading and long-term visual representation on the apparatus. This figure also shows the visible fertilizer impregnation (610) & the definitive line (310).

FIG. 3

In FIG. 3 (300) we see the direction of the seed is established down (510). This novel apparatus sets the proper seed direction (510) and depth (910) in FIG. 6 (600) when planting is occurring. The depth of these seed (120) in the soil (810) in FIG. 5 (500) is also predetermined base don't the seed (120) type adhered to the apparatus. Figure also shows fertilizer impregnation (610) & insertion tip (130).

FIG. 4

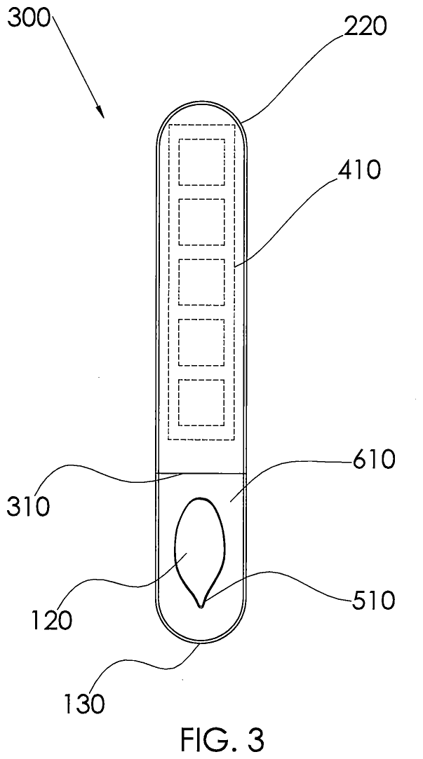

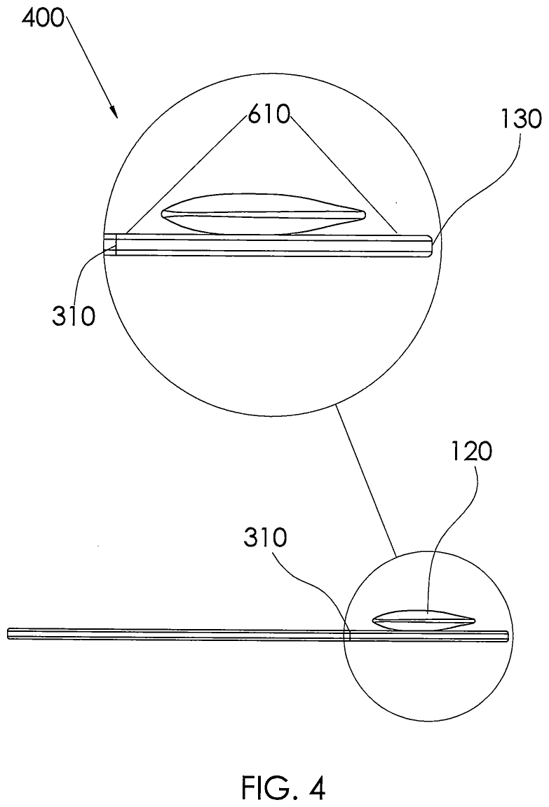

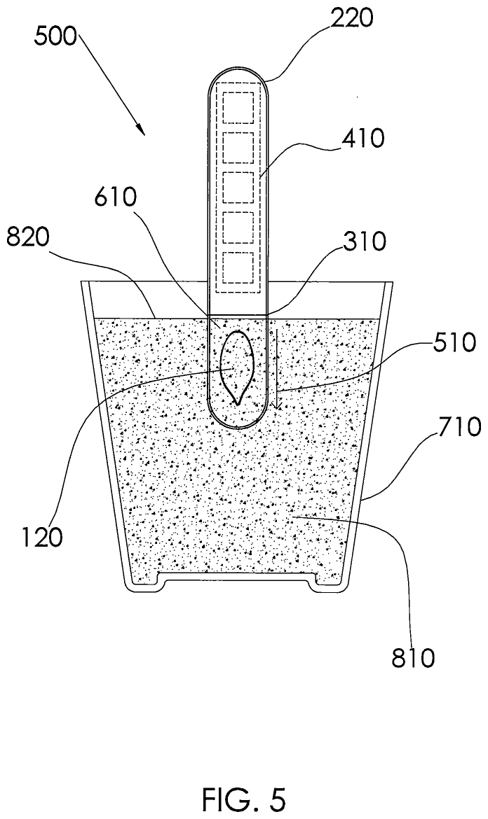

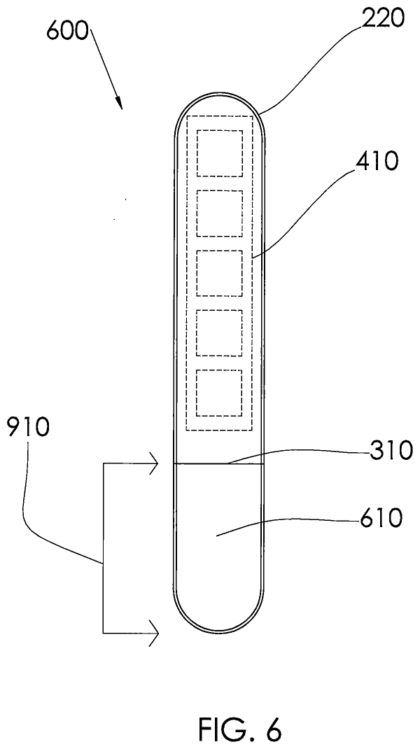

In FIG. 4 (400) shows a detailed view of the belt of FIG. 3 (300). The Fertilizer (610) shown in this figure is impregnated from the definitive line (310) to insertion tip (130) which has total length of 2″ (910) shown in FIG. 6 (600). Figure also shows Seed (120). Various embodiments of the present invention will be described in detail with reference to the drawings, in which like reference numbers represent like parts throughout several images. Reference to various embodiments does not limit the scope of the legal claims of the invention. The drawings presented herein do not limit the various embodiments according to the invention and are represented by way of example to illustrate the invention.

FIG. 5

In FIG. 5 (500) we see how the novel apparatus is inserted into the pot (710). The novel apparatus is inserted to the definitive line (310) to ensure the seed (120) and visible fertilizer impregnation (610) are below the soil (810). The definitive line (310) will be equal to the soil upper surface (820). This will ensure that the depth (510) of the seed (120) is correct. Figure also shows the Digging portion (220) & the laser etched seed (120) name label (410).

FIG. 6

In FIG. 6 (600) shows the fertilizer impregnation (610) at a measurement of 2 inches (910). Each variety of seed (120) will be positioned at a different depth from the definitive line (310) to insertion tip (130). Figure also shows the Digging portion (220) & the laser etched seed (120) name label (410).

### DETAILED DESCRIPTION OF THE INVENTION PA

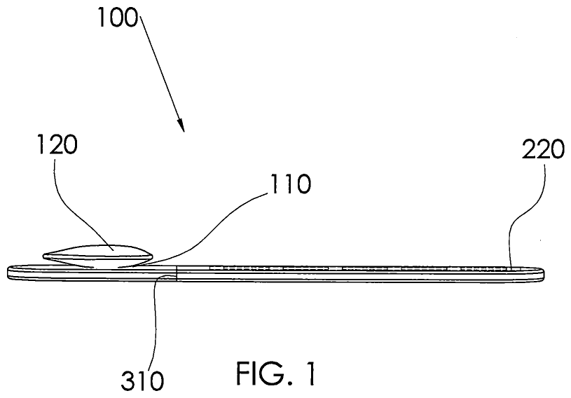

FIG. 1 shows the side view of the seed planting apparatus. This view shows the seed oriented on the apparatus at the proper depth. Once the apparatus is pushed into the ground, the seed will be located at the ideal depth for root propagation. This seed location is set during the manufacturing process. The adhesive that is also mentioned in this figure is designed to adhere the seed to the apparatus, while maintaining a safe bond for future human consumption. This edible adhesive is designed to be food safe. The apparatus itself is designed from a biodegradable wood material meant to breakdown in the soil over time. Using a material that is organic allows this novel product to ease consumers' minds concerning biological impacts.

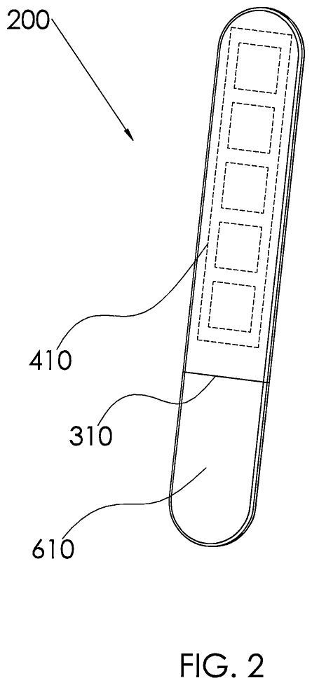

FIG. 2 is referencing the nomenclature of the seed that is adhered to the apparatus. It is to be noted that the nomenclature is to be laser etched into the material. This etching allows for long term visibility for the usable shelf-life of the product. Also visible in this figure is the fertilizer impregnation line. The fertilizer is impregnated into the apparatus up to the location of planting. This novel feature allows for end users to identify the exact location the apparatus must be planted at to allow for optimal root growth. This organic fertilizer is food safe, and this process allows for a slow, time release into the soil around the apparatus. This slow release allows for continual feeding of the plants root systems allowing for more advanced growth.

FIG. 3 is referencing the direction the seed is adhered to the apparatus. It is of the utmost importance that the seed direction is correct during the planting process to allow for optimal root growth. This processing of the seed direction is completed during the manufacturing process. The direction is set for each seed.

FIG. 4 is referencing the length of the fertilizer impregnation. This length is not only valid for planting depth that is referenced in FIG. 1, it is also mentioned that the fertilizer allows for a slow-release process into the soil. The predetermined length of the fertilizer impregnation, which is 2″ allows for a larger surface area to leach into the soil. This length of impregnation is also meant to visibly allow feedback to end users of the correct planting depth. Thus, various configurations of seed apparatus have been shown and described. It should be appreciated that the system shown and described is intended for illustrative purposes, and thus an invention has been provided. It should be understood that numerous variations, changes, and others that are obvious to specialists in this field of technology should be considered part of the present invention.

FIG. 5 is referencing the way the novel apparatus needs to be inserted into the pot of soil. The novel apparatus needs to be inserted to the definitive line so that the definitive line and top of soil are equal to each other. This ensures the impregnated fertilizer is completely below the soil and seeds are planted at the correct depth for proper root growth.

FIG. 6 is referencing the fertilizer impregnation from the definitive line to the bottom of the novel apparatus. Each seed has a specific depth that needs to be planted to ensure proper root growth. The measurement starts at the definitive line downward. For example, a carrot seed needs to be planted a half inch in the soil. The measurement starts at the definitive line down a half inch then the seed is attached to the novel apparatus at that point. Whereas a zucchini seed needs to be planted at one inch in the soil. Thus, for a zucchini seed it will need to be attached to the novel apparatus one inch down from the definitive line.

PATENT CITATIONS (5)

| | Publication number | Priority date | Publication date | Assignee Title |
|---|---|---|---|---|
| 1 | EP3038449B1 | Aug. 30, 2013 | May 30, 2018 | Precision Planting LLC Seed |
| | | | | delivery apparatus |
| 2 | U.S. Pat. No. 10,813,276B2 | *2017 Mar. 14 | Oct. 27, 2020 | Cote Ag Technologies, LLC Seed |
| | | | | delivery system |
| 3 | U.S. Pat. No. 3,749,035A | *1970 Dec. 28 | Jul. 31, 1973 | Deere & Co Precision depth seed |
| | | | | planter |
| 4 | U.S. Pat. No. 10,444,774B2 | Nov. 7, 2014 | Oct. 15, 2019 | Dawn Equipment Company |
| | | | | Agricultural system |
| 5 | U.S. Pat. No. 4,345,531A | *1980 Apr. 15 | Aug. 24, 1982 | Redl Narciss A Apparatus and |
| | | | | method for cultivating land |

1. The sowing depth for each seed is designed specifically for each seed. Meaning, each seed variety will have a different visual appearance, but the concept is the same.

2. The Fertilizer is impregnated into the substrate of the seed apparatus. This provides a prolonged period of fertilization.

3. The Seed Reticule is placed pointing down on all our seed apparatuses. This helps promote root growth.

4. The apparatus is identified with the same seed that is affixed to the apparatus.

5. The seed is affixed with an organic adhesive. This adhesive is bio-degradable and edible.

6. The apparatus can be used as a soil preparation device.

7. The Depth of the Seed is dictated by the line of the fertilizer liquid on the seed apparatus and the tip of the reticule.

8. The Seed Apparatus itself is Bio-degradable and useful for composting.

9. Each Apparatus makes planting seeds a quicker alternative to manual planting.

10. The seed Apparatus makes a significant marker for planning straight rows.

11. The Seed Apparatus allows for regular inspection on the germination progress of each plant, with a visual indicator of the plant germinating therein.

12. The Apparatus is customizable for large and small seed types as well as locations of the seeds.

13. The Seed Apparatus is useful in any climate that is deemed fit for the seed that is associated with the apparatus.
